(19) United States
(12) Patent Application Publication
(10) Pub. No.: US 2018/0025170 A1
(43) Pub. Date: Jan. 25, 2018

(54) FILE TRANSFER USING AN IN-BROWSER STAGING DATABASE

(71) Applicant: ZYPTONITE, INC., New York, NY (US)

(72) Inventors: Harri Hursti, New York (US); Misa Munde, Helsinki (FI)

(21) Appl. No.: 15/215,977

(22) Filed: Jul. 21, 2016

(51) Int. Cl. G06F 21/62; H04L 29/06; G06F 21/53; G06F 17/30; G06F 9/455

(52) U.S. Cl. CPC G06F 21/6218; G06F 17/30312; G06F 9/45529; G06F 21/53; H04L 63/166; G06F 2221/2149

(57) ABSTRACT

Methods and systems for data transfer include storing received data chunks in a staging database that is implemented within a browser sandbox. The stored data chunks into a single file. The single file is saved to a memory outside of the staging database.

### BACKGROUND

### Technical Field

The present invention relates to network file transfers and, more particularly, to the transfer of files using a browser sandbox as a staging area for data receipt.

### Description of the Related Art

Modern web browsers support file transfers over a limited number of different transfer protocols, including hypertext transfer protocol (HTTP), secure HTTP (HTTPS), and file transfer protocol (FTP). This transfer is handled inside the browser and its processes are inaccessible to outside software—essentially the file transfers occur within a “black box,” without any ability to process the data while the transfer is ongoing.

However, as communication needs change, this black box approach to file transfers has proven limiting. In one example, encryption of a data transfer in the black box approach is limited to the encryption mechanism supported by the browser (generally transport layer security (TLS)), which supports only data-in-motion and which greatly limits the available encryption technology and algorithm options that may be used. In addition, the host application has no control over various attacks which modify TLS operating parameters.

On the protocol level, the black box limits the protocol stack to TCP/IP and to server-client architectures, which greatly limits the types of file transfer schemes that can be implemented within the browser. One result of these limitations is that the data path is logically “gapped,” with encryption being provided along each leg of its path, but with the data being left exposed at each point.

### SUMMARY

A method for data transfer includes storing a plurality of received data chunks in a staging database that is implemented within a browser sandbox. The stored data chunks are assembled into a single file using a processor. The single file is saved to a memory outside of the staging database.

A method for data transfer includes receiving a plurality of data chunks with a data transfer protocol implemented within a browser sandbox. The data transfer protocol does not employ native browser data transfer tools. A plurality of received data chunks is stored in a staging database that is implemented within the browser sandbox. On-the-fly processing of the stored data chunks in the staging database is performed. The stored data chunks are assembled into a single file using a processor. The single file is saved to a memory outside of the staging database.

A system for data transfer includes a processor and a memory. A web browser residing in the memory and executed by the processor includes sandbox. A staging database is implemented within the web browser sandbox configured to store a plurality of received data chunks. The web browser implements a data transfer protocol in the sandbox that is configured to assemble the stored data chunks into a single file and to save the single file to a memory outside of the staging database.

These and other features and advantages will become apparent from the following detailed description of illustrative embodiments thereof, which is to be read in connection with the accompanying drawings.

### BRIEF DESCRIPTION OF THE SEVERAL VIEWS OF THE DRAWINGS

The disclosure will provide details in the following description of preferred embodiments with reference to the following figures wherein:

FIG. 1 is a block diagram illustrating a system for file transfer in accordance with the present principles;

FIG. 2 is a block diagram of a sandboxed staging database in accordance with the present principles;

FIG. 3 is a block/flow diagram of a method for data transfer in accordance with the present principles; and

FIG. 4 is a block diagram of a processing system in accordance with the present principles.

### DETAILED DESCRIPTION

Embodiments of the present principles provide expanded file transfer capabilities within a browser's protected memory space (the browser's “sandbox”) by implementing file transfers using the browser as a platform and storing received data in a staging database. Additional capabilities for on-the-fly data processing may be provided as well.

While many different forms of file transfer software exist and can be run independently of the web browser, operating within the browser's sandbox provides significant advantages. In the first place, such operation can help a user avoid stringent local security policies that prevent, for example, the installation of unapproved software. By operating within the browser itself, file transfers can be accomplished without the installation of any additional software. In addition, using the database to store received data improves security, as potentially malicious software can be stored and scanned in an inert state before being saved to the disk.

It is specifically contemplated that JAVASCRIPT® may be used to implement the present embodiments, because it is a well-developed programming language that is supported by many browsers, but it should be understood that any appropriate scripting or programming language may be used in its place.

While software that implements file transfers has been implemented in JAVASCRIPT®, for example through the WebSocket protocol or web real-time communication (WebRTC) application programming interface (API), saving data directly as a data blow from JAVASCRIPT® limits the file size that may be transferred to a few megabytes due to limitations in existing browser design architectures. The data paths provided by WebSocket and WebRTC were not intended to be used for file transfers, but because they are general purpose data paths, the present embodiments can employ those protocols. The file size limit is defined by various localstorage and sessionstorage limits that are set by the browser 104. Without some external storage being used, JAVASCRIPT® will store received data in RAM in an inefficient manner, quickly exhausting the memory allocatable for the browser instance that has the JAVASCRIPT® engine. To address this problem, the present embodiments store chunks of transferred data in a database that is stored in browser memory.

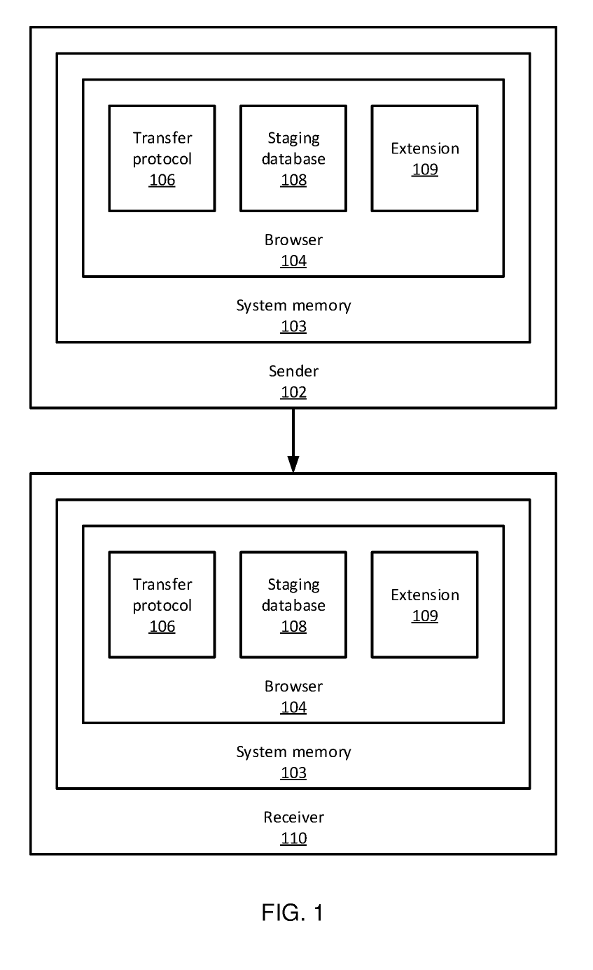

Referring now to the drawings in which like numerals represent the same or similar elements and initially to FIG. 1, a file transfer system 100 is shown. The system 100 includes a sender 102 and a receiver, each of them including a system memory 103. A browser 104 runs in the system memory 103 of each device, with the browser 104 implementing a transfer protocol 106 and a staging database 108 within its own sandbox. A “sandbox” is a term in computer security that refers to a tightly controlled set of resources that programs may run in, where the ability to interact with resources outside of the sandbox is restricted. The sandbox is essentially a virtual machine that cordons off a portion of the system memory 103 under the control of a program (e.g., the browser 104) and allows software (e.g., using only high-level execution inputs) to run within that memory without adversely affecting other programs. Therefore, when a language does not implement access to low-level primitives, malicious software cannot attempt to overcome the sandbox limitations by attempting to inject machine code, as the sandbox environment will not pass anything directly to the processor for execution.

It is specifically contemplated that the transfer protocol 106 may be implemented in JAVASCRIPT® as described above, which handles the transfer in any appropriate manner without using the browser's inaccessible “black box” mechanisms. The transfer protocol 106 at the receiver 110 receives the data and stores it as chunks in the staging database. This avoids the practical limits to the size of saved data.

In one specific embodiment, the staging database 108 may be implemented in the browser sandbox using IndexedDB, which is a web API for storing and indexing large data structures within browsers. IndexedDB provides a transactional database system that uses JAVASCRIPT® objects, rather than fixed columns and tables to store data. In one example, JAVASCRIPT® Object Notation (JSON) is used to serialize structured data in a text format, and JSON Object Signing and Encryption (JOSE) or proprietary alternative processes may be used to provide encryption, digital signatures, and message authentication codes (MACs) on the level of individual objects.

In one embodiment, direct storage of JAVASCRIPT® data objects and array buffers to the staging database 108 may be used to maximize system performance. However, additional functionality may be provided through the use of a browser extension 109, which is software that runs within the browser sandbox. Using the extension 109, an alternative type of direct processing is possible for the data stream. The extension 109 can directly handle data chunks in a blob-formatted representation of the data for optimized direct processing of files of arbitrary size. It should be understood that direct writing to the staging database 108 and extension-enhanced writing can be turned on as appropriate, for example in response to performance needs.

It is specifically contemplated that the transfer protocol 106 will transfer the data as chunks. Chunking refers to the breakdown of a file into smaller pieces. The file being processed can then be handled at the receiver 110 by indexing the incoming pieces of the file as JSON objects in the staging database 108. Transferring and storing the data in chunks enables transfer resumption in case the transfer is interrupted, asynchronous transmission, re-transmission of damaged chunks, error correction, safe analysis of potentially malicious content, freedom to use any encryption strategy, unlimited file sizes, and transmission compiled from messages from multiple sources.

The transfer protocol 106 may furthermore operate over either TCP or UDP. TCP provides guaranteed, error-free delivery of data chunks, while UDP does not provide such guarantees. In the case of UDP, it is up to the transfer protocol software to ensure the integrity of the data, including but not limited to ensuring that all packets are delivered, that chunks are serialized correctly, and that the chunks do not get corrupted. However, UDP provides advantages in some cases (for example when connections are unreliable).

Traditionally, file transfers by UDP have mimicked TCP behavior by requesting retransmission of missing or damaged chunks, but this uses the artificial concept of a transmission window to handle serializing and optimizing handshaking. In some use cases, for example when high-latency or high-error-rate data paths are used, mimicking TCP behavior is disadvantageous. Pre- and post-processing the data stream with error correction such as, e.g., Reed-Solomon, can eliminate or greatly reduce the need for retransmissions. In addition, retransmission can be obtained from an alternative source, e.g., via a lower bandwidth, but lower latency transmission channel.

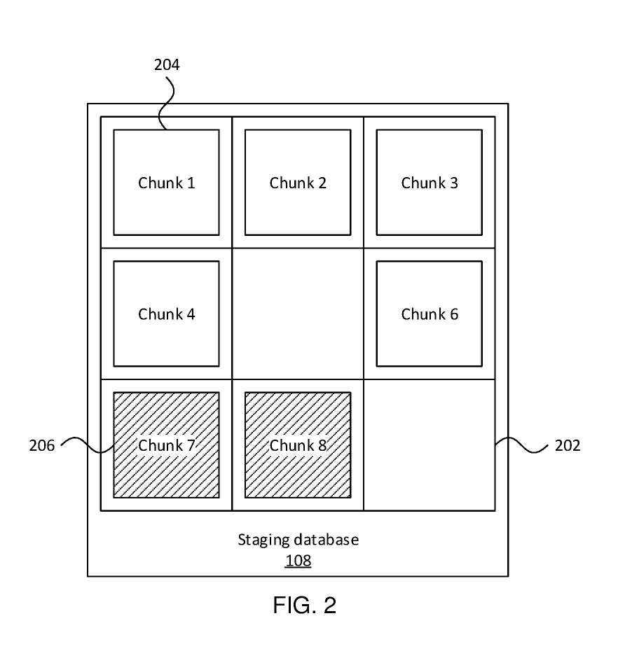

Referring now to FIG. 2, an illustration of staging database 108 is shown. As noted above, in one specific embodiment the staging database 108 is implemented using IndexedDB, but it should be understood that alternative databases may be employed instead. The staging database 108 is implemented in the browser's sandbox, so the transfer protocol 106 has access to the staging database and no external software is needed.

The staging database has multiple indexed data slots 202. As data chunks 204 arrive at the receiver 110, the transfer protocol 106 stores data chunks 204 into data slots. The data chunks 204 may not arrive in order, leaving gaps in the transferred data. These gaps may be preserved within the staging database 108 as shown or, alternatively, data slots 202 may be filled consecutively, with the data being reassembled when the received data is stored to disk.

In addition, data chunks can be processed on-the-fly in the staging database 108. For example, the plain data chunks 202 in FIG. 2 have already been processed, while the striped data chunks 206 have not yet been processed. It is specifically contemplated that encryption and decryption may be performed in this fashion, with each data chunk being processed as it arrives. Other operations may include a character set standard conversion or operating system compatibility conversions, for example ensuring left-to-right filenames are handled correctly in right-to-left language systems.

This approach to encryption provides true end-to-end encryption, because the carrier objects, the individual payload chunks, and the file itself can be separately secured on the content encryption and digital signature levels. Authentication and privacy are separated while providing forensic audit trail abilities to identify malicious and compromised data paths. The staging database 108 further provides an extra layer of data security against network surveillance. In particular, if there are multiple data sources (for example, in the case of peer-to-peer transfers), or if the data takes multiple paths through a network (which is more likely when UDP is used), it is possible for a malicious party controlling one of the paths to modify the data on the fly as it passes through. For example, this capability could be used by state-controlled firewalls, high-cost attacks that reroute data through processing centers, etc. In conventional file transfers, it would be impossible to identify and isolate the sources of such attacks.

The present embodiments protect against such attacks and make it easier to track the attackers. The additional layer of encapsulation of the already encrypted data has a separate key structure and signature, which increases the difficulty of modifying the data itself. In addition, the attacker will leave a fingerprint of the attack with the packets, which are cryptographically identifiable.

Storage of incoming information in the form of data chunks also renders that information harmless in the event that it includes malware. Many forms of malware are distributed over the internet and use unpublished vulnerabilities in browsers and in anti-malware software. In traditional file transfers, the file is first processed within the browser's “black box” and then written to a file on the disk. Anti-malware software can then inspect the file, but the file is already dangerous due to being in an executable form. File formats which are not normally executable can also pose a threat, as they are often handled in a more relaxed manner. Using the staging database 108 provides an opportunity to assess the incoming data as encoded data objects which cannot be executed.

The same feature provides non-possessive inspection for peer-to-peer transmission pre-screening. In pre-screened transfers, firewalls or other middleboxes in the transmission path inspect the file, potentially generating copies of the file in locations that are unknown to the sender and receiver. In some cases, a firewall conducting pre-screening may keep a copy for thirty days, may pass the file or parts of the file to secondary processing in a cloud facility, may retain suspicious files to a third party for their own product development purposes, or, in the case of peer-to-peer transfer, may store the file for processing by third-party software when can do any of the above and more.

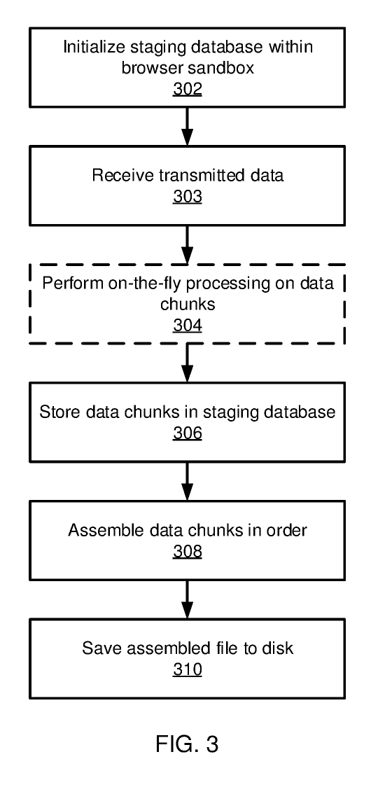

Referring now to FIG. 3, a method for receiving data is shown. Block 302 initializes staging database 108 within the sandbox of browser 104 in receiver 102. The receiver 110 begins to receive data transmitted by the sender 102 in block 303. The data may arrive chunked or may arrive as a continuous stream. The data may arrive according to any appropriate transfer protocol 106 (e.g., a TCP- or UDP-based protocol that may be directly peer-to-peer or may alternatively be mediated by one or more intermediate servers along one or multiple different transmission paths). It should be emphasized that both the transfer protocol 106 and the staging database 108 are implemented within the browser's sandbox—no external software is needed.

As data arrives at receiver 110, block 304 optionally performs on-the-fly processing of the data. This on-the-fly may include arbitrary operations such as, e.g., encryption, compression, serialization, malware inspection, etc. The use of a browser extension 109 may be needed to facilitate this processing.

In one embodiment, block 306 stores processed chunks 202 into the staging database 108. In an alternative embodiment, where on-the-fly processing is omitted (e.g., to improve performance), the data chunks 202 are written directly to the staging database. In the embodiment where unchunked data arrives as a continuous stream, block 306 breaks the data into appropriately sized chunks before storing the chunks in the staging database 108.

When the time comes to write the received data to disk (e.g., when all of the chunks have been received and when any on-the-fly processing has been performed), block 308 assembles the data chunks into the full file. This assembly may include requesting retransmission of any chunks that arrived corrupted or which did not arrive at all and may further include a decoding step if error correction coding was employed. Block 310 saves the assembled file to disk. It should be understood that blocks 308 and 310 may operate concurrently, with the chunks being assembled as they are written to disk.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk, and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

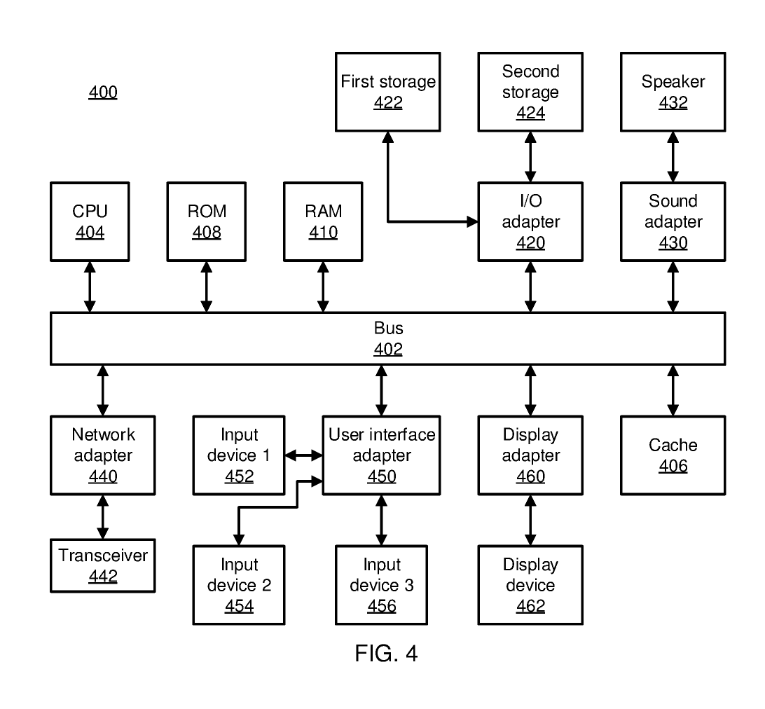

Referring now to FIG. 4, an exemplary processing system 400 is shown which may represent the sender 102 and/or the receiver 110. The processing system 400 includes at least one hardware processor (CPU) 404 operatively coupled to other components via a system bus 402. A cache 406, a Read Only Memory (ROM) 408, a Random Access Memory (RAM) 410, an input/output (I/O) adapter 420, a sound adapter 430, a network adapter 440, a user interface adapter 450, and a display adapter 460, are operatively coupled to the system bus 402.

A first storage device 422 and a second storage device 424 are operatively coupled to system bus 402 by the I/O adapter 420. The storage devices 422 and 424 can be any of a disk storage device (e.g., a magnetic or optical disk storage device), a solid state magnetic device, and so forth. The storage devices 422 and 424 can be the same type of storage device or different types of storage devices.

A speaker 432 is operatively coupled to system bus 402 by the sound adapter 430. A transceiver 442 is operatively coupled to system bus 402 by network adapter 440. A display device 462 is operatively coupled to system bus 402 by display adapter 460.

A first user input device 452, a second user input device 454, and a third user input device 456 are operatively coupled to system bus 402 by user interface adapter 450. The user input devices 452, 454, and 456 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 452, 454, and 456 can be the same type of user input device or different types of user input devices. The user input devices 452, 454, and 456 are used to input and output information to and from system 400.

Of course, the processing system 400 may also include other elements (not shown), as readily contemplated by one of skill in the art, as well as omit certain elements. For example, various other input devices and/or output devices can be included in processing system 400, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 400 are readily contemplated by one of ordinary skill in the art given the teachings of the present principles provided herein.

Having described preferred embodiments of file transfer using an in-browser staging database (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A method for data transfer, comprising:
storing a plurality of received data chunks in a staging database that is implemented within a browser sandbox;
assembling the stored data chunks into a single file using a processor; and
saving the single file to a memory outside of the staging database.

2. The method of claim 1, further comprising receiving the plurality of received data chunks with a data transfer protocol implemented within the browser sandbox.

3. The method of claim 2, wherein the data transfer protocol and the staging database are implemented in JAVASCRIPT®.

4. The method of claim 3, wherein the data transfer protocol is implemented using one of a group consisting of WebSocket and WebRTC.

5. The method of claim 2, wherein the data transfer protocol does not employ native browser data transfer tools.

6. The method of claim 1, further comprising performing on-the-fly processing of the stored data chunks in the staging database before the stored data chunks are assembled into a single file.

7. The method of claim 6, wherein on-the-fly processing of the stored data chunks performs at least one function selected from the group consisting of encryption, decryption, compression, decompression, serialization, error correction decoding, and malware inspection.

8. The method of claim 1, wherein the received data chunks are encrypted on a per-chunk basis according to a first encryption protocol.

9. The method of claim 8, wherein the received data chunks are furthermore encrypted using transport layer security.

10. A computer readable storage medium comprising a computer readable program for data transfer, wherein the computer readable program when executed on a computer causes the computer to perform the steps of claim 1.

11. A method for data transfer, comprising:
receiving a plurality of data chunks with a data transfer protocol implemented within a browser sandbox, wherein the data transfer protocol does not employ native browser data transfer tools;
storing a plurality of received data chunks in a staging database that is implemented within the browser sandbox;
performing on-the-fly processing of the stored data chunks in the staging database;
assembling the stored data chunks into a single file using a processor; and
saving the single file to a memory outside of the staging database.

12. A system for data transfer, comprising:
a processor;
a memory;
a web browser residing in the memory and executed by the processor that comprises a sandbox; and
a staging database implemented within the web browser sandbox configured to store a plurality of received data chunks, wherein the web browser implements a data transfer protocol in the sandbox configured to assemble the stored data chunks into a single file and to save the single file to a memory outside of the staging database.

13. The system of claim 11, wherein the transfer protocol is further configured to receive the plurality of received data chunks.

14. The system of claim 13, wherein the data transfer protocol and the staging database are implemented in JAVASCRIPT®.

15. The system of claim 14, wherein the data transfer protocol is implemented using one of a group consisting of WebSocket and WebRTC.

16. The system of claim 13, wherein the data transfer protocol does not employ native browser data transfer tools.

17. The system of claim 11, further comprising a browser extension configured to perform on-the-fly processing of the stored data chunks in the staging database before the stored data chunks are assembled into a single file.

18. The system of claim 17, wherein on-the-fly processing of the stored data chunks performs at least one function selected from the group consisting of encryption, decryption, compression, decompression, serialization, error correction decoding, and malware inspection.

19. The system of claim 11, wherein the received data chunks are encrypted on a per-chunk basis according to a first encryption protocol.

20. The system of claim 19, wherein the received data chunks are furthermore encrypted using transport layer security.
